(19) United States
(12) Patent Application Publication
(10) Pub. No.: US 2003/0057143 A1
(43) Pub. Date: Mar. 27, 2003

(54) Method and apparatus for facilitating handling of communications

(76) Inventors: Eric Lieberman, Essex, CT (US); Brian Lowery, Naugatuck, CT (US); Julian P. Kirk, Riner, VA (US); Randal J. Kirk, Belspring, VA (US); William P. Nance, Stanfield, NC (US); Dennis K Lee, Charlotte, NC (US); Michael H. Grayson, Charlotte, NC (US); Joanne Grogan, Manchester, CT (US)

Correspondence Address: NIXON PEABODY, LLP, 8180 GREENSBORO DRIVE, SUITE 800, MCLEAN, VA, 22102, US

(21) Appl. No.: 10/121,477

(22) Filed: Apr. 12, 2002

Related U.S. Application Data
(63) Continuation-in-part of application No. 09/956,990, filed on Sep. 21, 2001.

(51) Int. Cl. B07C 5/00; B07C 7/00

(52) U.S. Cl. 209/630

(57) ABSTRACT

A method and apparatus for handling physical communications. A physical communication, such as a letter or a package is received and sorted. The sorting includes assigning one or more of a plurality of predetermined values to each of one or more of a plurality of predetermined characteristics relating to the physical communication. A handling procedure, including one or more handling steps is selected for the communication based on the values assigned in said assigning step and rules correlating the values to a handling procedure. The handling procedure can be modified based on destination specific rules.

### RELATED APPLICATION DATA

This application is a continuation-in-part of copending application Ser. No. 09,956,990 filed on Sep. 21, 2001, the disclosure of which is incorporated herein by reference.

### BACKGROUND OF THE INVENTION

1. Field of the Invention

The invention relates generally to management of communications and more specifically to a method and apparatus for facilitating handling of electronic and physical communications such as e-mail messages, facsimile transmissions, letters and packages.

2. Description of the Related Art

Businesses, and even residences, are deluged by a tremendous amount of communications, such as letters and packages received in the mail, on a daily basis. Storing, managing, and retrieving such communications is time-consuming and costly. Worse yet, documents may be mis-filed or lost in the “system.” Organizations often utilize expensive document management systems in an attempt to organize electronic and physical documents.

The use of electronic communications, such as electronic mail (“email”) and digital copies of physical documents has become widespread. Electronic communications reduce storage space and the consumption of resources. For example, paper for copies of documents require wood pulp from trees, significant amounts of energy, and various undesirable byproducts of the paper making process. Various systems are known for converting physical documents into electronic documents.

For example U.S. Pat. No. 5,867,597 and U.S. Pat. No. 5,893,908 each disclose an electronic document management system in which paper documents are scanned and stored in electronic form. A descriptor database includes a plurality of descriptors along with a list of documents including the descriptor. Descriptors are generated by subjecting the documents to complex processing. Accordingly, document queries and retrieval can be facilitated by using the descriptors.

Electronic creation, editing, and storage of documents has become commonplace. However, physical communications, such as letters, packages and other tangible objects remain prevalent because of the tactile feel and high resolution thereof. Further paper documents are easy to review and annotate, are portable, and in fact represent a “universal standard” for display, a feature not yet available in the electronic world. Of course, packages and other physical objects cannot be duplicated in electronic form. Current document management techniques do not address the continued use of paper and other forms of physical communications. In particular, such techniques do not provide a mechanism for handling physical communications, such as routing the communications to desired destinations, in accordance with consistent business rules and workflow processes. In fact, even in the case of electronic communications, conventional document management systems merely permit retrieval of documents upon request and do not permit flexible handling of the documents.

It is known to automatically direct electronic documents to a desired destination. For example, a product known as LMDS MailRoom applies predetermined filters to the content of scanned documents and directs the documents to destinations based on the filters. However, the use of filters is not flexible and cannot be applied to physical communications that are not adaptable to being converted to electronic format, such as packages.

In addition to the advantages of electronic documents noted above, there are other reasons for avoiding or minimizing the handling of physical communications. For example, biological weapons, such as anthrax and smallpox, can be, and have been, distributed through the mail by malicious parties. In some cases, this has required medical tests for large populations, the widespread use of antibiotics, and vaccines, and decontamination procedures. Even these expensive measures have not prevented illness and even death. Accordingly, it is desirable to minimize the handling of physical communications and to conduct as much of such handling as is possible under controlled conditions and in accordance with consistent procedures. Additionally, because many communications are handled in a manual manner, or otherwise are not controlled and logged in detail, communication content is not captured and processed. This often relates in lost productivity, lost business opportunities, and security breaches.

### SUMMARY OF THE INVENTION

A first aspect of the invention is a method for handling physical communications comprising the steps of receiving a physical communication, assigning one or more of a plurality of predetermined values to each of one or more of a plurality of predetermined characteristics relating to the physical communication, selecting a handling procedure for the communication based on the values and applying the handling procedure to the communication.

A second aspect of the invention is a method for handling physical communications comprising the steps of receiving a physical communication, applying a translational language to characteristics of the physical communication, selecting a handling procedure for the communication based on the translational language and applying the handling procedure to the communication.

A third aspect of the invention is a method for creating a handling rule set for handling physical communications, comprising the steps of, assigning one or more of a plurality of predetermined values to each of one or more of a plurality of predetermined characteristics relating to the physical communication to form a value matrix, correlating a handling procedure for the communication to the value matrix to form a handling rule and storing the handling rule for future use in applying the handling rule to the physical communications.

A fourth aspect of the invention is a method for handling physical communications comprising the steps of receiving a physical communication, ascertaining one or more features of the physical communication based on the external appearance of the physical communication, selecting either a first handling procedure or a second handling procedure for the communication based on the features. The first handling procedure includes physical delivery of the physical communication to an intended recipient and the second handling procedure includes converting the contents of the physical communication to electronic data representing the contents of the physical communication and delivering the electronic data to the intended recipient.

A fifth aspect of the invention is a computer readable medium having instructions recorded thereon for handling physical communications, said instructions comprising, instructions for prompting an agent to assign one or more of a plurality of predetermined values to each of one or more of a plurality of predetermined characteristics relating to a physical communication, instructions for selecting a handling procedure for the communication based on the values and instructions for causing the handling procedure to be applied to the communication.

A sixth aspect of the invention is a computer readable medium having instructions for handling physical communications, said instructions comprising instructions for-applying a translational language to characteristics of the physical communication, instructions for selecting a handling procedure for the communication based on the translational language and instructions for causing the handling procedure to be applied to the communication.

A seventh aspect of the invention is a computer architecture for controlling the handling of physical communications, said architecture comprising, an operator interface module configured to prompt an agent to assign one or more of a plurality of predetermined values to each of one or more of a plurality of predetermined characteristics relating to the physical communication, a selection module configured to select a handling procedure for the communication based on the values and a command module operatively coupled to handling equipment to issue commands to handling equipment causing the handling procedure to be applied to the communication.

### BRIEF DESCRIPTION OF THE DRAWING

The invention is described through a preferred embodiment and the attached drawing in which:

FIG. 1 is a flowchart of a method of managing communicants of the preferred embodiment;

FIG. 2 is a schematic representation of the columns, characteristics, and potential values for a communication of the preferred embodiment;

FIG. 3 is a table illustrating an example of a set of handling rules of the preferred embodiment;

FIG. 4 is a flowchart of a modification of the preferred embodiment having a two level translation procedure;

FIG. 5 is a screen shot illustrating the user interface for specifying destination devices and preferences;

FIG. 6 is a table illustrating an example of a set of device rules of the preferred embodiment; and

FIG. 7 is a table illustrating an example of a set of modified handling rules of the preferred embodiment.

### DETAILED DESCRIPTION

Recently the field of “computational linguistics” has been explored in a theoretical nature. In computational linguistics, the formal techniques of computational models of intelligence are applied to the study of human linguistics. It has been proposed that it is a unique human ability to construct the world as it is revealed through language. The ability to categorize parts of phrases to select a specific overall meaning from the constituent parts of the phrases or sentences seems to be characteristic of human behavior uniquely. The continuous refinement and redefinition of what role an object plays in our environment, and how we conceptualize that object as having different properties in different contexts is known as the process of “cocomposition.”

All words are ambiguous to some extent. Even words that appear to have one fixed sense can exhibit multiple meanings in different contexts. ‘Room’, for example, can mean a physical object or the spatial enclosure defined by this object. The conceptual relation between two senses of the same word is referred to as “logical polysemy.” Further, the concept of “metonymy,” in which a figure of speech involving the substitution of one noun for another of which it is an attribute or which is closely associated with it, renders language highly complex to understand. Examples of metonymy are “the kettle boils” or “he drank the cup.” Because language is highly complex and the full understanding of language is uniquely human (or at least requires a tremendous amount of processing power), previous attempts to automate the routing of communications have failed to ascertain the context of the communication and thus cannot accurately handle a communication without a great deal of human intervention.

The preferred embodiment of the invention facilitates determination of the context of communications, such as physical communication, by a human agent with minimal training or by an automated agent mechanism. A translational language is provided to permit determination of the content and context of the communication by an agent and to permit automatic handling procedures, including routing of the communication to a desired destination. Further, the preferred embodiment is adapted to be used for management of physical communications. The phrase “physical communications” as used herein refers to any communication having at least a component part that is tangible without the need for a computer or other rendering device. For example, letters, packages and post cards are physical communications.

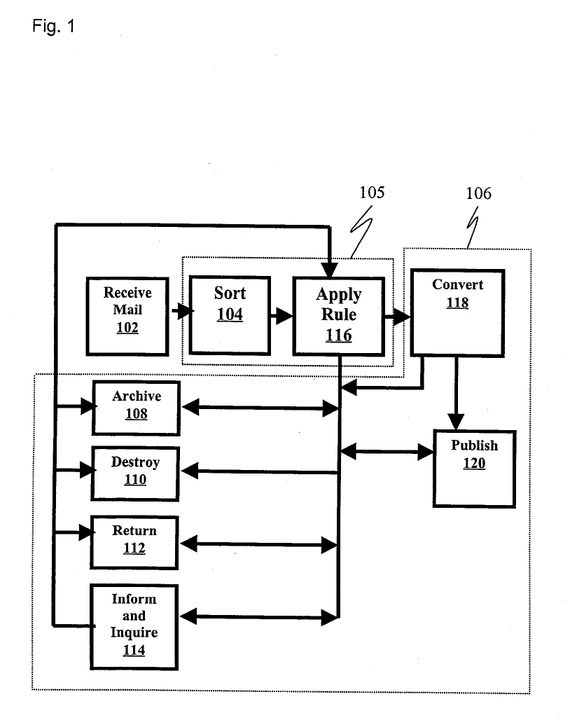

A method of managing physical communications in accordance with a preferred embodiment of the invention is illustrated in FIG. 1. The preferred embodiment can be utilized within any type of organization, i.e. any entity receiving communications, such as a business, government institution, mail service provider, or the like. Method 100 begins at step 102 in which a physical communication, a letter or package received through the mail for example, is received in a company mailroom, the facility of a third party providing mail handling procedures for the company, or the like. In step 104 a sorting procedure is applied to the communication in order to determine what type of communication has been received and the context of the communications. Step 104 includes ascertaining features of the physical communication and is described in detail below.

Depending on the results of the sort procedure in step 104, an appropriate handling rule, or plural handling rules, is applied in step 116 and various handling steps according to the rule are effected in handling step 106. For example, the communication can be archived, i.e., sent to a facility for storage, in step 108, destroyed in step 110, returned to the sending party in step 112, converted to electronic form in step 118, or published in step 120. Further, specified parties can be notified of receipt of the communication and inquiry can be made with respect to features of the communication, such as whether the communication was expected, whether the sending party is recognized, or the like, in step 114. Depending on the results of the inquiry, the communication can then be subjected to any one or more of steps 108, 110, 112, 118 and 120.

Assuming the results of step 116 or step 114 indicate that the communication should be routed in electronic form to a recipient within the organization, the communication, e.g. a letter, is opened and the contents of the letter is converted to electronic form through, scanning, hand keying, or in any other manner in step 118. The electronic form of the contents can be of any format or protocol, such as ASCII, TIFF, PDF, MS Word™, or the like. Known equipment and procedures can be used to open the communication, remove the letter or other content, and scan the content. These procedures can be conducted by automated equipment in a known manner or through manual processing. In either event, such procedures can be accomplished while minimizing the exposure of humans to the letter to prevent any contaminants or other dangerous substances contained in or on the letter from affecting personnel.

After the content of the communication has been converted to electronic form in step 118, the content, in electronic form can be archived in electronic format in step 108 and/or published in step 120. Alternatively, in the event the communication is to be routed in physical form, step 120 can be accomplished without the need for converting in step 118. Step 120 can be accomplished through email, printout and intra office mail delivery, making the content available to the recipient through pick up from a Web site, physical delivery, or the like. The term “publish” as used herein refers to any mechanism for making content available to desired recipients. In step 116, a translational language is applied to the communication to render a machine readable code or human readable instructions indicative of the handling procedures of the communication in accordance with handling rules. As will become apparent below, the handling procedure can be determined based on one or more levels of rules.

The preferred embodiment permits mail and other physical communications to be handled and, if appropriate, delivered to the appropriate recipient with minimal handling of the physical communication itself. The detailed procedures steps 104 and 116 of the preferred embodiment are disclosed below. All logical processes of the preferred embodiment can be accomplished by a general purpose computer executing the appropriate software. The various functions can be programmed to define modules for effecting the function of the invention. Programming of the software will be apparent to one of ordinary skill in the art based on the functionality disclosed herein. The computer can be coupled to known handling equipment to issue commands to cause the handling equipment to effect the desired handling procedure.

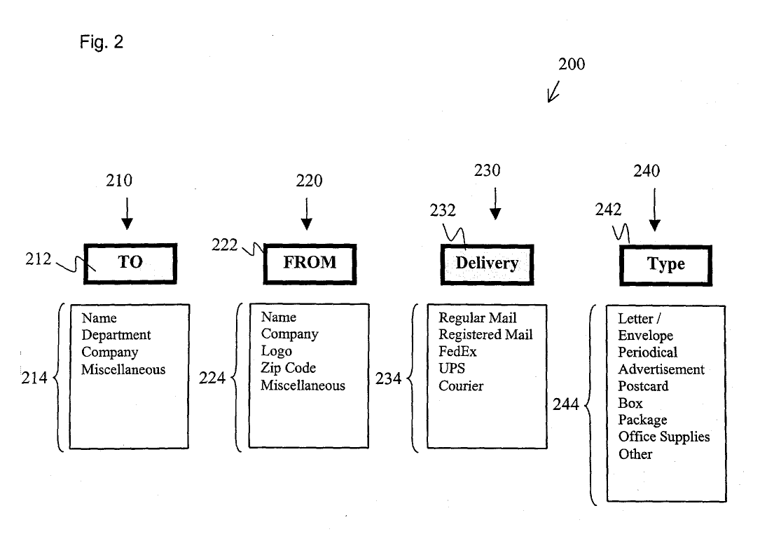

FIG. 2 illustrates sorting matrix 200 used by the preferred embodiment for the sorting procedure in step 104 above. A plurality, four in the preferred embodiment, of columns 210, 220, 230, and 240 are shown. Each of the columns represents a predefined communication characteristic (212, 222, 232, 242) and includes a plurality of values (214, 224, 234, 244) that can be assigned to the corresponding characteristic. Ascertainable characteristics of the physical communication, preferably those characteristics ascertainable from the exterior of the communication are used for assigning the values as will become apparent below. The proper value for one or more of the characteristics can be assigned and the communication can be handled based on predefined rules applied to the series of values i.e., the “value matrix”.

Column 210 has characteristics 212 that relate to the entity to which the communication is addressed. This information can be culled from the address label on the communication by scanning and character recognition, by human interpretation and input through a keyboard. The potential values 214 associated with column 210 are NAME, DEPARTMENT, COMPANY, and MISCELLANEOUS. For example, if the letter received in step 102 is addressed to “Attention Sales Department,” the value assigned to column 210 will be DEPARTMENT and the specific department, i.e., Sales Department will be saved as an attribute for subsequent processing. For example, optical scanning and character/word recognition can be used to determine the content of the address label. Table 1 below lists the possible values for column 210 of the preferred embodiment and the conditions under which each value would be assigned. Of course, in each case, specifics such as the specific addressee can be recorded as attributes for subsequent processing.

TABLE 1

| | |
|---|---|
| Name | The communication includes the name of the |
| | individual addressee. |
| Department | The communication does not include a |
| | specific individual name but includes a |
| | department. |
| Company | The communication is directed to a company |
| | generally. |
| Miscellaneous | The communication is not addressed to an |
| | individual, a department, or a company. For |
| | example, “Occupant”. |

Column 220 has characteristics 222 that relate to the originator of the communication, i.e. the person who sent the letter. The potential values 224 associated with column 222 are NAME, COMPANY, LOGO, ZIP CODE, AND MISCELLANEOUS. For example, if the return address label or letter heading does not have an individual's name but includes a company name, the value assigned to column 220 will be COMPANY. Table 2 below lists the possible values 224 for column 220 and the conditions under which each value would be assigned. Of course, in each case, the specific identity can be recorded for subsequent processing as an attribute of the value. For example, if the communication is from John Smith, the value will be NAME and the attribute of the value will be “John Smith.”

TABLE 2

| | |
|---|---|
| Name | The communication includes a sender's |
| | name. |
| Company | The communication does not include an |
| | individual's name but does include a |
| | company name as sender. |
| Logo | The communication does not include a |
| | company name or an individual name but |
| | includes a logo design indicative of origin. |
| Zip Code | The communication does not include a |
| | company name, individual name, or logo but |
| | does includes a zip code of the sender. |
| Miscellaneous | The communication does not include a |
| | company name, individual name, logo, or zip |
| | code of sender. |

Column 230 has characteristic 232 that relates to the delivery method of the communication, e.g., the package carrier or service in the preferred embodiment. The potential values 234 associated with column 230 are REGULAR MAIL, REGISTERED MAIL, FEDERAL EXPRESS™, UNITED PARCEL SERVICE™, and COURIER (such as a local package courier service or other miscellaneous delivery service). Of course, the value 234 assigned to characteristic 232 of the preferred embodiment corresponds directly to the delivery service that can be ascertained from the mailing label or other indicia on the package. Table 2 below lists possible values 234 for column 230 and the conditions under which each value would be assigned. The type of delivery service can be indicative of necessary signature requirements and procedures as well as the urgency of the communication.

TABLE 3

| | |
|---|---|
| Regular Mail | The package indicia indicates that the |
| | package was delivered by the USPS regular |
| | mail service |
| Registered Mail | The package indicia indicates that the |
| | package was delivered by the USPS |
| | registered mail service |
| FedEx ™ | The package indica indicates that the |
| | package was delivered by Federal Express ™ |
| UPS ™ | The package indicia indicates that the |
| | package was delivered by United Parcel |
| | Service ™ |
| Courier | The package indicia indicates that the |
| | package was delivered by a miscellaneous |
| | courier |

Column 240 has characteristic 242 that relates to the type of communication, i.e. letter, periodical, and the like. The potential values 244 associated with column 240 are LETTER/ENVELOPE, PERIODICAL, ADVERTISEMENT, POSTCARD, BOX, PACKAGE, OFFICE SUPPLIES, and OTHER. Once again, the value assigned to column 240 can correspond to the type of communication which can be ascertained from a visual inspection and input manually or automatically into the system. Table 4 below lists the possible values 244 for column 240 and the conditions under which each value would be assigned. Also, attributes can be stored for subsequent use. For example, the value might be PERIODICAL and the attribute could be “Newsweek.”

TABLE 4

| | |
|---|---|
| Letter/Envelope | The communication is contained in an |
| | envelope and does not appear to be office |
| | supplies or an advertisement. |
| Periodical | The communication is a periodical |
| Advertisement | The communication is an advertisement. |
| Post Card | The communication is a post card that is not |
| | an advertisement. |
| Box | The communication is in a box but does not |
| | appear to be office supplies or an |
| | advertisement. |
| Package | The communication is in a package other |
| | than a box but does not appear to be office |
| | supplies or an advertisement. |
| Office Supplies | The communication appears to contain Office |
| | Supplies. |
| Other | The communication does not fit any of the |
| | values above. |

It can be seen that the values assigned to the characteristics provide a great deal of information without the need to open the communication and thus can provide direction in handling the communication. Of course, there can be any number of characteristics and corresponding values to effect the sorting procedure in accordance with appropriate business rules. Also, the characteristics and values can be predetermined based on the type of business, the organizational flow of the business, the number of employees, the division of work, and the like. The characteristics can relate to any aspect of a potential communication, and there can be any number or type of values for selection in each characteristic. The attributes discussed above could be used as values. For example, one set of selectable values could include each employee of a company.

Table 5 below lists the possible values for column 210 of a modification to the preferred embodiment and the conditions under which each value would be assigned. In this modification, the specifics, such as the specific addressee, are values of column 210 corresponding to characteristic 212.

TABLE 5

| | |
|---|---|
| John Doe | The communication includes John Doe as |
| | the addressee. |
| Tom Brown | The communication includes Tom Brown as |
| | the addressee. |
| AAA Industries, Inc. | The communication is directed to the |
| | Company AAA industries, Inc. generally. |
| Sales Department | The communication is directed to the Sales |
| | Department generally. |

Table 6 below lists the possible values for column 220 of a modification to the preferred embodiment and the conditions under which each value would be assigned. In this modification, the specifics, such as the specific person or company sending the communication, are values of column 220 corresponding to characteristic 222.

TABLE 6

| | |
|---|---|
| Jim Brown | The communication includes Jim Brown in |
| | the return address label |
| Janet Smith | The communication includes Janet Smith as |
| | the addressee. |
| Widget Industries, Inc. | The communication is from Widget |
| | Industries, Inc. generally. |
| Accounts Receivable | The communication is form the Accounts |
| Department | Receivable Department generally. |

In the modifications discussed above with respect to Table 5 and Table 6, specifics of the recipient and the sender are recorded as values instead of value attributes. This permits rules and processing to be simplified but may require more values. For example, values 214 may include every person and department in a company. Values 224 could include all anticipated senders. Keep in mind that potential values and rules can be eliminated, modified or added at any time using known software operator interfaces. However, access to tools for such changes can be limited to those having authority to make such changes. Attributes can be recorded with respect to the values of Table 5 and Table 6. For example, such attributes can include a sender's title or any other information relevant to handling.

When a communication, such as a package or a letter, is received in step 102, a screen can display a list of characteristics and corresponding values to be selected, similar to that illustrated in FIG. 2, for sorting step 104. Any appropriate user interface can be used. In the case of the preferred embodiment, the standard Microsoft Windows™ user interface is used as disclosed in the parent application incorporated herein by reference.

An agent, such as mailroom personnel or an automated reception mechanism, can sort the communication by assigning values assigned to one or more characteristics in accordance with the communication and by entering attributes of the value. For example, when the value is NAME, the attribute could be “JOHN DOE,” i.e. the specific information of the value. The agent can select the proper value for one or more of the characteristics and the communication can be handled based on the selected values and predefined rules as described in detail below. The values can be selected based on characteristics ascertainable from the exterior of the communication. For example, the content and/or address label of a communication can be manually inspected or scanned and converted to digital form by an automated system. This information can be used for assigning values to the characteristics and for recording attributes.

An agent, such as mailroom personal or an automated system, would be able to assign values to all or most categories based on the outward appearance of the communication with minimal training. In fact, an agent could be employed by a service that receives communications for a plurality of businesses and the categories and values displayed could vary based on the destination, i.e. the addressee of the communication. Such a situation could be handled efficiently with minimal training because the techniques are similar for all communications regardless of the type of business that the communication is directed to. As noted above, there can be any number of categories and corresponding values. Also, the categories and values can be predetermined based on the type of business, the organizational flow of the business, the number of employees, the division of work, internal and external business processes and the like. The categories can relate to any characteristic of potential communications, and there can be any number or type of values for selection in each category.

Assuming, in sorting step 104, the agent has assigned the value matrix, i.e. list of values, of “COMPANY/COMPANY/REGULAR MAIL/LETTER” in order corresponding to the categories discussed above and illustrated in FIG. 2. This matrix can then be “translated” to permit one or more handling rules to be applied in step 116. The translation can include a plain language statement directing a human agent in how to handle the communication. Alternatively, the translation can include computer executable instructions for directing an automated system in how to handle the communication. In either case, the translating is generated based on the value matrix, recorded attributes, and predefined rules determined in the manner described in detail below. Should the agent not be able to determine each value based on the appearance of the communication, the translation can be generated based on the entered values and can serve to assist the agent in inquiring about further information that will help assign the proper values. It will become apparent below that sorting step 104 and apply step 116 comprise a translation step 105 for translating communicating information into handling procedures.

As noted above, the procedure for handling the communication is determined based on predefined rules as applied to the value matrix assigned to the communication. Also noted above and illustrated in FIG. 1, the handling procedure 106 can include one or more handling steps. For example, the communication can be published to one or more recipients in step 120, can be archived in step 108, can be destroyed in step 110, can be returned to the sender or other party in step 112, or can be the subject of “inform and inquire” step 114. Further, a combination of these steps can be accomplished for a single communication. For example, in the case of a letter, it may be desirable to convert the letter to electronic form in step 118, publish the letter in step 120 to the desired recipient via electronic means, such as a graphics or text file sent by electronic mail, and destroy the hard copy in step 110.

The handling rules to be applied in step 116 for handling communications can be determined and recorded in any manner. However, the preferred embodiment provides a user interface for assisting the user in creating and recording the rules. Of course, the rules are predetermined and thus do not need to be created over and over again. However, the rules can be changed to correct for inefficiencies or to compensate for changes in personnel, workflow, organization, or other variables.

Handling rules essentially define the translational equivalent of the translational language used in the preferred embodiment. In other words, the handling rules can correlate specific handling procedures to specific value matrices. The method of creating and modifying handling rules can be implemented on a computer as a front end interface in the form of a “wizard” or the like as disclosed in the parent application referenced above. Handling rules can be created based on input from business managers, sales personnel, consultants, human resources persons, or any other appropriate persons for supplying the appropriate information about the organization for which the handling rules are to be applied.

The characteristics described above with respect to the preferred embodiment can be changed. For example there can be more characteristics, less characteristics, or different characteristics as is required by the organization and its business model, personnel, and the like. Each value matrix can correspond to a specific handling procedure. A best match algorithm can be used for value matrices that are not correlated to a handling procedure by a rule. Handling rules can be fashioned in various ways depending on the business model, work flow, and other factors to translate the value matrices into handling procedures. Further, handling procedures can include a destination such as a person or a building.

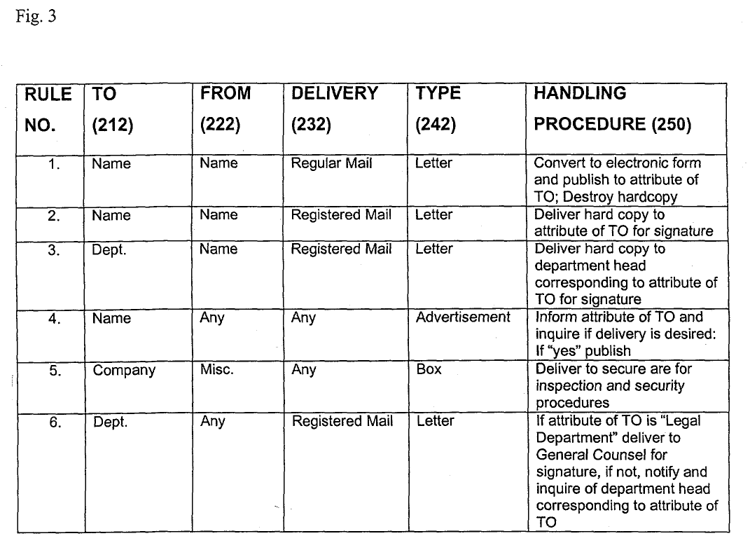

FIG. 3 illustrates an example of a small set of handling rules that can be used in Apply step 116. In FIG. 3, there are six rules. Each rule has a value matrix, i.e., the combination of values for characteristics 212, 222, 232, and 242, and a corresponding handling procedure 250. Of course, the value matrix for any particular communication can be determined in the manner described above with respect to FIG. 2. When applying rules to a communication, the rules are scanned to determine if any of rules include a value matrix that corresponds (i.e. is similar or identical) to the value matrix of the communication as determined in step 104 of FIG. 1. If so, the handling procedure 250 of the corresponding rule is used for handling of the communication. Various algorithms can be used to determine which rule, if any, most closely corresponds to any particular value matrix. Of course, the rule set illustrated in FIG. 3 is only exemplary of a portion of a rule set. Actual rule sets, including those created using the preferred embodiment, can include many more rules. However, there is no minimum or maximum number of rules that can be used with the invention.

Rule number (1) of FIG. 3 is applied when the value matrix for a communication is NAME/NAME/REGULAR MAIL/LETTER, or a similar value matrix. In such a case the content is converted to electronic form in step 118, and published, to the recipient who was recorded as an attribute of NAME, in step 120. Further, the hard copy of the communication is destroyed in step 110.

Rule number (2) is applied when the value matrix is NAME/NAME/REGISTERED MAIL/LETTER, or a similar value matrix. In this case, the hard copy of the communication is published n step 120 by being delivered to the attribute of TO, i.e., the recipient, for signature and review.

Rule number (3) is applied when the value matrix is DEPT/NAME/REGISTERED MAIL/LETTER, or a similar value matrix. In this case, a hard copy of the communication is published in step 120 by being delivered to a department head corresponding for the attribute of TO recorded in step 104. For example, if the communication was addressed to “Sales Department”, the system can determine that John Doe is the Head of Sales, through a lookup table or the like, and can have the communication published to John Doe in step 120.

Rule number (4) is applied when the value matrix is NAME/ANY/ANY/ADVERTISEMENT. Note that “ANY” refers to any one of the possible values for that characteristic. In this case, the recipient, i.e., the attribute of TO is informed and asked if they want to receive the advertisement (step 114) and if so, the communication is delivered, i.e. published to the recipient (step 120).

Rule number (5) is applied to a value matrix of COMPANY/MISC/ANY/BOX and requires that the communication be delivered, i.e., published in step 120, to a secure area for inspection and security procedures.

Rule number (6) applies logic to the attributes. In particular, of the value matrix is DEPT/ANY/REGISTERED MAIL/LETTER, the communication will be delivered to general counsel if the attribute of TO is “Legal Department” (step 120). Otherwise, the communication will be handled by notifying the department head of the attribute of TO and inquiring about the communication (step 114).

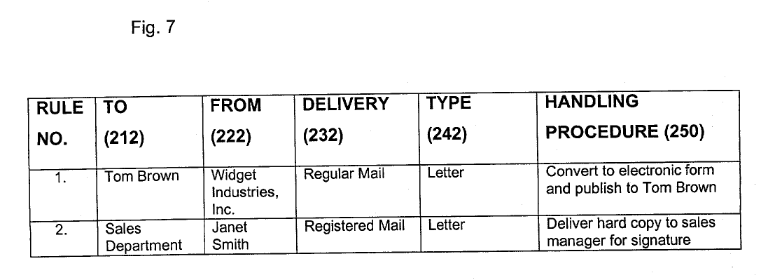

FIG. 7 illustrates another example of a small set of handling rules that can be used in Apply step 116 in combination with the alternative values of Table 5 and Table 6. In FIG. 7, there are two rules. Each rule has a value matrix, i.e., the combination of values for characteristics 212, 222, 232, and 242, and a corresponding handling procedure 250. Of course, the value matrix for any particular communication can be determined in the manner described above with respect to FIG. 2. As noted above, when applying rules to a communication, the rules are scanned to determine if any of rules include a value matrix that corresponds (i.e. is similar or identical) to the value matrix of the communication as determined in step 104 of FIG. 1. If so, the handling procedure 250 of the corresponding rule is used for handling of the communication. Various algorithms can be used to determine which rule, if any, most closely corresponds to any particular value matrix. Of course, the rule set illustrated in FIG. 7 also is only exemplary of a portion of a rule set. Actual rule sets, including those created using the preferred embodiment, can include many more rules.

To create a rule set, the preferred embodiment includes an algorithm, that can be executed on a general purpose computer, for correlating the handling procedures with potential value matrices. For example, a configuration screen can include drop down menus corresponding respectively to the four characteristics 212, 222, 232, and 242 of FIG. 2. Further, the user can select one or more handling steps to associate with a value matrix to define the handling procedure. For example, the selectable handling steps can include steps 108, 110, 112, 114, 118, and 120, or any combination thereof. Further, the handling steps can be modified by recorded attributes or logic applied to the attributes as described above. The value matrix can be stored with the selected mapped handling procedure. The rules can be stored in any format, such as a lookup table, plain delimited text, or as any other type of database. All rules can be displayed in the manner illustrated in FIG. 3 or in any other manner.

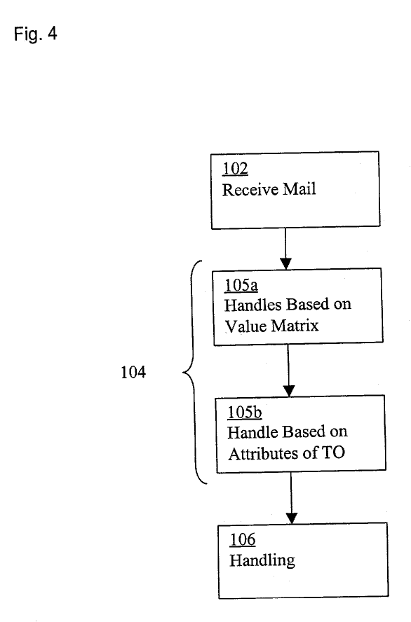

FIG. 4 illustrates a modification to the preferred embodiment having a two level translation procedure 105. As noted above, rules can be used to publish a communication to a destination, which can be a person, department, group, physical or virtual inbox, or any other entity or location. However, when a communication is routed to a particular person, that person may not be in the location anticipated, e.g. they may not be at their desk. Accordingly, the preferred embodiment provides for each destination to have one or more devices associated therewith. In the case of the destination being a person, the devices can be the person's personal computer text pager, a mobile phone, or the like. In the case of a department or a group, devices can be various devices in the group, such as a first person's computer, a second person's computer and the like. Communications can be published to the various devices based on the destination's schedule, e.g. hours in office, hours commuting to office, hours in meetings, and the like. In step 105a, of FIG. 4, the translation is based on the value matrix in the manner described above to determine a handling procedure. In step 105b, the handling procedure is revised based on the destination device preference.

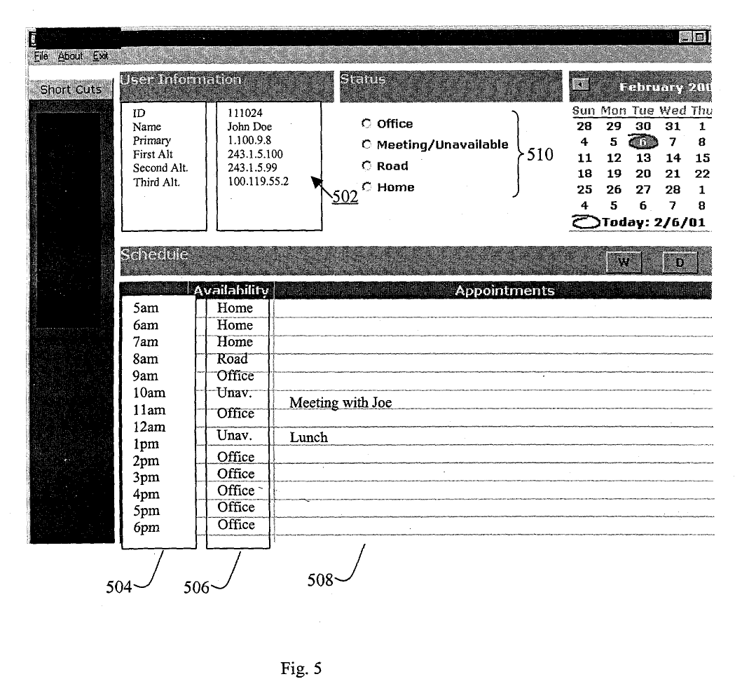

FIG. 5 illustrates a schedule screen for a typical destination. In this example, the destination is a person named “John Doe.” Identifying information for the destination can be entered into field 502, including the person's name, ID number, department, and address to the person's (destination) various devices, such as computers, alphanumeric pagers, mobile phones or other handheld device number. The addresses in the preferred embodiment are in the form of IP addresses for a primary, first alternate, and second alternate device. Field 504 lists the times of day in a manner similar to conventional scheduling programs of personal information managers (PIMs). Field 506 lists the availability status of the person in correspondence to each hour of the work day. In the preferred embodiment, the user can select from one of four statuses, Office, Meeting/Unavailable, Road, and Home. Field 508 lists the person's scheduled appointments for the day.

The information in field 508 can be imported from a conventional PIM or other scheduler. Alternatively, the information can be entered directly in field 508 manually, such as when the person uses the preferred embodiment as their primary scheduling tool. The information in field 506 can be culled from information in the PIM or other scheduler or can be entered manually by selecting a time of day or appointment and selecting one of status buttons 510. Further, the status information in field 506 can be generated based on a default template. For example, the person may construct a default template that indicates that they are in the office from 9 am to 5 pm. Commuting, i.e. Road, from 8 am to 9am and from 5 pm to 6 pm, and home at all other hours. These defaults can be used to populate field 506 and can be overridden when an appointment is entered or a different button 510 is selected. The schedule information permits the preferred embodiment to direct a communication, or a message related thereto, to a particular device based on the destination schedule. The term “schedule” as used herein refers broadly to the status of a destination with respect to time.

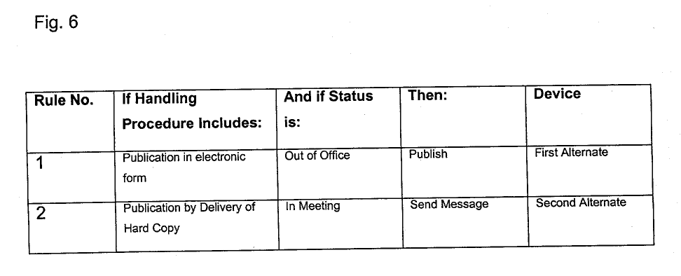

FIG. 6 illustrates device rules for handling communications to be applied in translating step 105b for directing communications to one or more of plural devices associated with the destination. Such rules can be created, as disclosed in the parent application, through a scripting box which includes one or more fields, such as drop down menus for associating conditions with various devices. For example, the user can select a status (Home, Office, Meeting/Unavailable, or Road) from a drop down menu and a primary device, such as their computer.

The device rules are applied after handling rules and are thus applied to the result of step 105a. For example, as illustrated in FIG. 6, device rule number (1) states that, if the handling procedure determined in step 105a results in publication in electronic form and the recipient schedule indicates “Out of Office” at that particular time, then the handling procedure is revised to include the step of publishing to the first alternate device for that recipient. Similarly, device rule number (2) states that, if the handling procedure includes publication through delivery of a hardcopy and the recipient schedule indicates “In Meeting” then send a message to the second alternate device notifying the recipient of the communication. For example, the second alternate device can be an alphanumeric pager and the message can be “A package has just been delivered to you.” Further, the message can include attribute information indicating the sender or other package information.

The invention provides organizational knowledge of and control over the communication handling function. An intelligent and preplanned system can be constructed and evolved through rules. An agent need not have a great deal of experience or training to handle communication efficiently and effectively. Rules can be defined for handling communications based on the assigned values. Further, the preferred embodiment is transparent to the originating party of the communications. The invention can be implemented on any type of computer, such as a personal computer, a mini computer, or via a computer system, such as a client server architecture. Any type of interface can be used to collect data and the data can be stored in any format or manner. The invention can be used for a single organization, part of an organization, or for handling all calls for plural organizations. The method can be used for managing any type of communication. For example, the invention can be used to handle facsimile messages or other printed documents, electronic mail messages, instant electronic messages, packages, or any other human readable or computer readable communication. The various procedures of the invention can be accomplished through automated means or by a human. For example, the communication can be scanned and parsed by a computer and values can be assigned automatically. Handling of communications can be accomplished over electronic channels or through physical transportation of the communication.

The invention provides organizational knowledge of and control over the communication management function. An intelligent and preplanned system can be constructed and evolved through rules. An agent need not have a great deal of experience or training to handle communications efficiently and effectively. Further unnecessary physical contact with the communication can be minimized to reduce potential harm due to explosives, biohazards, or other harmful contents.

The invention has been described through a preferred embodiment. However, the embodiment is not intended to be limiting to the scope of the invention as defined by the appended claims and legal equivalents.

What is claimed is:

1. A method for handling physical communications comprising the steps of:
receiving a physical communication;
assigning one or more of a plurality of predetermined values to each of one or more of a plurality of predetermined characteristics relating to the physical communication;
selecting a handling procedure for the communication based on the values assigned in said assigning step; and
applying the handling procedure to the communication.

2. The method as recited in claim 1, wherein said assigning step comprises:
prompting an agent to select one or more values for each characteristic.

3. The method as recited in claim 1, wherein said selecting step comprises applying one or more handling rules to the values assigned in said assigning step, each of said rules correlating one or more combinations of values to a handling procedure.

4. The method as recited in claim 3, wherein said handling procedure includes a destination and wherein said method further comprises the step of modifying the handling procedure based on current status of the destination.

5. The method as recited in claim 3, further comprising the step of recording one or more attributes for at least one of the values.

6. The method as recited in claim 5, wherein said selecting step comprises applying logic to the attributes.

7. The method as recited in claim 1, wherein the handling procedure comprises at least one of converting the format of the communication, archiving the communication, destroying the communication, generating an inquiry relating to the communication, returning the communication to the sender, and publishing the communication.

8. The method as recited in claim 1, wherein the handling procedure comprises publishing the content of the communication;

9. The method as recited in claim 8, wherein said publishing step comprises forwarding the content of the communication to a recipient in electronic form.

10. The method as recited in claim 8, wherein said publishing step comprises forwarding the communication to a recipient in physical form.

11. The method as recited in claim 4, wherein said modifying step comprises applying one or more device rules, each of said device rules including logic functions that modify the handling procedure based on temporal information of the destination.

12. The method as recited in claim 1, wherein said characteristics include the intended recipient of the communication.

13. The method as recited in claim 1, wherein said characteristics include the sender of the communication.

14. The method as recited in claim 1, wherein said characteristics include the method of delivery of the communication.

15. The method as recited in claim 1, wherein said characteristics include the type of the communication.

16. The method as recited in claim 1, wherein said handling procedure comprises one or more handling steps.

17. The method as recited in claim 16, wherein said handling steps comprise at least one of archiving the communication, destroying the communication, returning the communication to the sender, converting the communication to another form, and publishing the communication.

18. A method for handling physical communications comprising the steps of:
receiving a physical communication;
applying a translational language to characteristics of the physical communication;
selecting a handling procedure for the communication based on the translational language; and
applying the handling procedure to the communication.

19. A method as recited in claim 18, wherein said applying step comprises assigning one or more of a plurality of predetermined values to each of one or more of a plurality of predetermined characteristics relating to the physical communication.

20. A method as recited in claim 19, wherein said selecting step comprises selecting a handling procedure for the communication based on the values assigned in said assigning step.

21. A method for creating a handling rule set for handling physical communications, comprising the steps of:
assigning one or more of a plurality of predetermined values to each of one or more of a plurality of predetermined characteristics relating to the physical communication to form a value matrix;
correlating a handling procedure for the communication to the value matrix to form a handling rule; and
storing the handling rule for future use in applying the handling rule to the physical communications.

22. A method as recited in claim 21, wherein said characteristics include the intended recipient of the communication.

23. The method as recited in claim 21, wherein said characteristics include the sender of the communication.

24. The method as recited in claim 21, wherein said characteristics include the method of delivery of the communication.

25. The method as recited in claim 21, wherein said characteristics include the type of the communication.

26. A method for handling physical communications comprising the steps of:
receiving a physical communication;
ascertaining one or more features of the physical communication based on the external appearance of the physical communication;
selecting either a first handling procedure or a second handling procedure for the communication based on the features ascertained in said ascertaining step, wherein said first handling procedure includes physical delivery of the physical communication to an intended recipient and said second handling procedure includes converting the contents of the physical communication to electronic data representing the contents of the physical communication and delivering the electronic data to the intended recipient; and
applying the handling procedure to the physical communication.

27. A method as recited in claim 26, wherein said ascertaining step further comprises informing an intended recipient of receipt of the physical communication and requesting feature information relating to the physical communication from the intended recipient.

28. The method as recited in claim 26, wherein said handling procedure comprises one or more handling steps.

29. The method as recited in claim 28, wherein said handling steps comprise at least one of archiving the communication, destroying the communication, returning the communication to the sender, converting the communication to another form, and publishing the communication.

30. A computer readable medium having instructions recorded thereon for handling physical communications, said instructions comprising:
instructions for prompting an agent to assign one or more of a plurality of predetermined values to each of one or more of a plurality of predetermined characteristics relating to a physical communication;
instructions for selecting a handling procedure for the communication based on the values; and
instructions for causing the handling procedure to be applied to the communication.

31. The medium as recited in claim 30, wherein said instructions for prompting comprise instructions for prompting an agent to select one or more values for each characteristic.

32. The medium as recited in claim 30, wherein said instructions for selecting comprise instructions for applying one or more handling rules to the values, each of said rules correlating one or more combinations of values to a handling procedure.

33. The medium as recited in claim 30, further comprising instructions for modifying the handling procedure based on current status of the intended destination of the communication.

34. The medium as recited in claim 30, further comprising instructions for prompting an agent to record one or more attributes for at least one of the values.

35. The medium as recited in claim 34, wherein said instructions for selecting comprises instructions for applying logic to the attributes.

36. The medium as recited in claim 30, wherein said instructions for causing include instructions for at least one of converting the format of the communication, archiving the communication, destroying the communication, generating an inquiry relating to the communication, returning the communication to the sender, and publishing the communication.

37. The medium as recited in claim 30, wherein said instructions for causing include instructions for publishing the content of the communication.

38. The medium as recited in claim 37, wherein said instructions for publishing comprise instructions for forwarding the content of the communication to a recipient in electronic form.

39. The medium as recited in claim 37, wherein said instructions for publishing comprise instructions for forwarding the communication to a recipient in physical form.

40. The medium as recited in claim 33, wherein said instructions for modifying comprise instructions for applying one or more device rules, each of said device rules including logic functions that modify the handling procedure based on temporal information of the destination.

41. The medium as recited in claim 30, wherein said characteristics include the intended recipient of the communication.

42. The medium as recited in claim 30, wherein said characteristics include the sender of the communication.

43. The medium as recited in claim 30, wherein said characteristics include the method of delivery of the communication.

44. The medium as recited in claim 30, wherein said characteristics include the type of the communication.

45. The medium as recited in claim 30, wherein said instructions for selecting a handling procedure comprise instructions for selecting one or more handling steps.

46. The medium as recited in claim 45, wherein said handling steps comprise at least one of archiving the communication, destroying the communication, returning the communication to the sender, converting the communication to another form, and publishing the communication.

47. A computer readable medium having instructions for handling physical communications, said instructions comprising:
instructions for applying a translational language to characteristics of the physical communication;
instructions for selecting a handling procedure for the communication based on the translational language; and
instructions for causing the handling procedure to be applied to the communication.

48. The medium as recited in claim 47, wherein said instructions for applying comprise instructions for prompting an agent to assign one or more of a plurality of predetermined values to each of one or more of a plurality of predetermined characteristics relating to the physical communication.

49. The medium as recited in claim 48, wherein said instructions for selecting comprise instructions for selecting a handling procedure for the communication based on the values.

50. A computer architecture for controlling the handling of physical communications, said architecture comprising:
an operator interface module configured to prompt an agent to assign one or more of a plurality of predetermined values to each of one or more of a plurality of predetermined characteristics relating to the physical communication;
a selection module configured to select a handling procedure for the communication based on the values; and
a command module operatively coupled to handling equipment to issue commands to handling equipment causing the handling procedure to be applied to the communication.

51. The computer architecture as recited in claim 50, wherein said selection module is operative to apply one or more handling rules to the values, each of said rules correlating one or more combinations of values to a handling procedure.

52. The computer architecture as recited in claim 51, wherein said commands include a destination and wherein said command module is operative to modifying the handling procedure based on current status of the destination.

53. The computer architecture as recited in claim 52, wherein said user interface module is operative to prompt the agent to enter one or more attributes for at least one of the values.

54. The method as recited in claim 53, wherein said selection module is operative to apply logic to the attributes.
